(19) United States
(12) Patent Application Publication
(10) Pub. No.: US 2022/0216533 A1
(43) Pub. Date: Jul. 7, 2022

(54) METHOD FOR NEUTRALISING AN ELECTROCHEMICAL GENERATOR

(71) Applicant: COMMISSARIAT À L'ÉNERGIE ATOMIQUE ET AUX ÉNERGIES ALTERNATIVES, Paris (FR)

(72) Inventor: Emmanuel Billy, Grenoble (FR)

(21) Appl. No.: 17/595,162

(22) PCT Filed: May 12, 2020
(86) PCT No.: PCT/EP2020/063204

§ 371 Date: Nov. 10, 2021

(30) Foreign Application Priority Data
May 15, 2019 (FR) FR1905070

(51) Int. Cl. H01M 10/54; H01M 6/52; H01M 10/0525

(52) U.S. Cl. CPC H01M 10/54; H01M 10/0525; H01M 6/52

(57) ABSTRACT

A method for neutralizing an electrochemical generator comprising a negative electrode containing lithium or sodium and a positive electrode, the method comprising a step, in which the electrochemical generator is brought into contact with an ionic liquid solution comprising an ionic liquid and a so-called oxidizing redox species capable of being reduced on the negative electrode so as to discharge the electrochemical generator.

### TECHNICAL FIELD

The present invention relates to a method for neutralising an electrochemical generator, such as an accumulator or an Li-Ion, Na-Ion or lithium-metal battery, in particular with a view to recycling thereof and/or storage thereof.

More specifically, it is a method wherein the electrochemical generator is made safe with a solution containing an ionic liquid and a redox active species. The redox active species makes it possible to neutralise the electrochemical generator by discharging it. The ionic liquid makes it possible to implement this step in complete safety and in particular by avoiding the formation of an explosive atmosphere.

The electrochemical generator can then be opened in complete safety and the reprocessable fractions can be recycled.

### Prior Art

An electrochemical generator is an electricity-production device converting chemical energy into electrical energy. It may be a case for example of cells or accumulators.

The market for accumulators, and in particular lithium accumulators of the Li-ion type, is greatly expanding at the present time, firstly because of the so-called roaming applications (smartphone, computer, photographic apparatus, etc.) and secondly because of novel applications related to mobility (electric and hybrid vehicles) and so-called stationary applications (connected to the electrical network).

Because of the increase in the number of accumulators over recent years, the question of recycling thereof has therefore become a major challenge.

Conventionally, a lithium-ion accumulator comprises an anode, a cathode, a separator, an electrolyte and a casing.

Generally, the anode is formed from graphite mixed with a binder of the PVDF type deposited on a sheet of copper, and the cathode is a metallic lithium insertion material (for example LiCoO₂, LiMnO₂, LiNiO₂, Li₃NiMnCoO₆ or LiFePO₄) mixed with a binder and deposited on an aluminium sheet.

The electrolyte is a mixture of non-aqueous solvents and lithium salts, and, optionally, additives for slowing down the secondary reactions.

The operation is as follows: during charging, the lithium reinserts from the metal oxide and inserts itself into the graphite, where it is thermodynamically unstable. During discharge, the process is reversed and the lithium ions are inserted in the metallic lithium oxide.

As it is used, ageing causes a loss of capacity and the cell must be recycled.

However, a large number of accumulators or batteries of accumulators to be recycled are still at least partially charged and crushing thereof produces sparks and significant ignitions or even explosions, especially with primary lithium cells (Li—SOCl₂).

Damaged cells must also be recycled. However, these cells may have deposits of metallic lithium on the anode, which, exposed to air or water, are highly reactive.

The cells, at the end of life and/or damaged, to be recycled must therefore be treated with the greatest care.

The method for recycling accumulators comprises a plurality of steps:
a pretreatment step including a dismantling phase and a make-safe phase,
thermal and/or hydrometallurgical treatments for recovering the various reprocessable materials and metals contained in these cells and accumulators.

At the present time, the main problem lies in the phase of making these lithium-based electrochemical systems (primary and secondary) safe.

This is because, when a loss of confinement occurs, leakages of electrolyte occur, which is a toxic, flammable and corrosive product, in liquid form and also gaseous. The vapours thus generated and mixed with the air may then form an explosive atmosphere (ATEX). This is liable to ignite in contact with an ignition source of the spark type or a hot surface. The result is then an explosion causing thermal effects and pressure effects. In addition, the electrolyte salts such as lithium hexafluorophosphate LiPF₆, lithium tetrafluoroborate LiBF₄, lithium perchlorate LiClO₄ and lithium hexafluoroarsenate LiAsF₆ may give off particularly toxic and corrosive fumes containing phosphorus, fluorine and/or lithium. For example, there may be the formation of hydrofluoric acid (HF) during the thermal degradation of Li-ion batteries.

To remedy these drawbacks, it is possible to crush the batteries in a chamber with controlled atmosphere and pressure. By way of example, the document WO 2005/101564 A1 describes a method for recycling a lithium anode battery by hydrometallurgical method, at ambient temperature and under an inert atmosphere. The atmosphere comprises argon and/or carbon dioxide. The two gases will drive out the oxygen and form a gaseous protective ceiling above the crushed load. The presence of carbon dioxide will lead to initiating a passivation of the metallic lithium by forming lithium carbonate on the surface, which slows down the reactivity of this metal. Hydrolysis of the crushed load containing lithium leads to the formation of hydrogen. To avoid the risks of ignition of the hydrogen and of explosion, the crushed load containing lithium is added to the aqueous solution in a highly controlled manner, and very strong turbulence above the bath is created. This operation is associated with an oxygen-depletion of the atmosphere. The water becomes rich in lithium hydroxide and the lithium is recovered by adding sodium carbonate or phosphoric acid.

In the method of the U.S. Pat. No. 5,888,463, the cells and accumulators are made safe by a cryogenic method. The cells and accumulators are frozen in liquid nitrogen at −196° C. before being crushed. The crushed material is next immersed in water. To avoid the formation of H₂S, the pH is maintained at a pH of at least 10 by adding LiOH. The lithium salts formed (Li₂SO₄, LiCl) are precipitated in the form of carbonate by adding sodium carbonate.

The document CA 2 313 173 A1 describes a method for recycling lithium ion cells. The cells are first cut in an inert atmosphere devoid of water. A first organic solvent (acetonitrile) dissolves the electrolyte and a second organic solvent (NMP) dissolves the binder. The particulate insertion material is next separated from the solution and reduced by electrolysis.

In the document WO 2011/113860 A1, a so-called dry method (“dry technology”) is described. The temperature of the crusher is maintained at between 40 and 50° C. and the mixture of hydrogen and oxygen, released from the batteries, is eliminated, by a cyclonic air movement, to minimise the risks of initiation of fire. The pieces of battery and dust, recovered after sieving, are cooled to ambient temperature. The extraction of the lithium appears to be achieved by reaction with the oxygen and moisture in the air, causing risks related to the simultaneous presence of hydrogen, oxygen and heat propitious to combustion and explosion. In addition, the electrolyte is degraded, causing risks, losses and difficulties with respect to the management of the dust and gases.

The UmiCore VAL'EAS™ method, described in the article by Georgi-Maschler et al. (“Development of a recycling process for Li-ion batteries”, Journal of Power Sources 207 (2012) 173-182) combines pyrometallurgical and hydrometallurgical treatments. The batteries, dismantled, are directly introduced into a furnace. The pyrometallurgical treatment deactivates them: the electrolyte evaporates at around 300° C.; the plastics are pyrolysed at 700° C. and the rest is finally melted and reduced at 1200-1450° C. Some of the organic materials contained in the cells serve as reducing agent in the method. The aluminium and lithium are lost. The iron, copper and manganese are recovered in aqueous solution. The cobalt and nickel are recovered in the form of LiCoO₂ and Ni(OH)₂ and recycled to form cathode materials. However, this type of heat treatment gives rise to high energy consumption and causes strong degradation of the components of the battery.

The document EP 0 613 198 A1 describes a method for recovering materials coming from lithium cells. The cells are cut either under high-pressure water jet or under an inert atmosphere to avoid initiation of fire. Then the lithium reacts with the water, an alcohol or acid in order to form respectively lithium hydroxide, a lithium alkoxide or a lithium salt (LiCl for example). However, the safeguarding achieved with cutting under high-pressure water jet requires a heavy consumption of water and generates H₂ gases under air.

At the present time, the various methods described above require implementing high-temperature treatments, cryogenic treatments, and/or treatments under controlled atmosphere, which are conditions that are difficult to implement industrially and/or expensive.

### DESCRIPTION OF THE INVENTION

One aim of the present invention is to propose a method for making it possible to remedy the drawbacks of the prior art, and in particular a method for neutralising an electrochemical generator that can easily be implemented industrially, not requiring the use of high temperatures, very low temperatures, and/or a controlled atmosphere.

This aim is achieved by a method comprising a step during which an electrochemical generator, comprising a negative electrode containing lithium and sodium and a positive electrode, is put in contact with an ionic liquid solution comprising an ionic liquid and a so-called oxidising redox species able to be reduced on the negative electrode so as to discharge the electrochemical generator.

The invention is distinguished fundamentally from the prior art by the use of a step of discharging the electrochemical generator, in the presence of an ionic liquid solution comprising an ionic liquid and a redox species. This step leads to the electrochemical generator being made safe, providing the extraction of the lithium or sodium of the negative electrode (anode) while avoiding the risks of ignition and/or explosion. The method is not a thermal method and makes it possible to manage the step of opening the electrochemical accumulator. It can be carried out at ambient temperature (20-25° C.) and/or in air.

The method makes it possible not only to respond to the problems of making the accumulators and cells safe, but also to the economic and environment constraints.

Being able to be reduced on the negative electrode means that the active species can react either directly on the negative electrode (anode), in the case where the casing of the accumulator is open, or on another element electrically connected to the anode, such as the anodic current collector, the terminal of the anode or earth when the anode is electrically connected to earth.

Hereinafter, when lithium is described, the lithium may be replaced by sodium.

For example, in the case of a lithium-metal accumulator, the reaction of reduction of the so-called oxidising redox species leads to the oxidation of the metallic lithium in ionic form.

According to another example, in the case of a lithium-ion accumulator, the reaction of reduction of the so-called reducing redox species leads to the disinsertion of the lithium ion of the active material of the negative electrode.

The free ions extracted from the anode migrate through the ionic conductive electrolyte and are immobilised in the cathode, where they form a thermodynamically stable lithium oxide. Thermodynamically stable means that the oxide does not react violently with water and/or air.

Advantageously, the solution comprises a second so-called reducing redox species able to be oxidised on the positive electrode, the so-called oxidising redox species and the so-called reducing redox species forming a redox species pair.

Redox pair, also referred to as a redox mediator or electrochemical shuttle, means an oxidising/reducing pair (Ox/Red) in solution, the oxidant of which can be reduced on the anode (negative electrode) and the reducer of which can be oxidised on the cathode (positive electrode). The oxidation of the reducer and the reduction of the oxidant make it possible to form new oxidising/reducing species and/or to regenerate the species initially present in solution. The method is economical since the redox pair in solution simultaneously provides both the redox reactions at the electrodes/terminals of the electrochemical generator, so that the consumption of reagent is zero; the solution can be used for making a plurality of electrochemical generators safe successively and/or in a mixture.

The redox species makes or make it possible to significantly or even totally discharge the electrochemical generator. In addition, in the event of rupture of the package, they will react with the internal components, so as to reduce the difference in potential between the electrodes (anode and cathode). This internal discharge also participates in making the electrochemical generator safe through reducing the chemical energy of the electrodes (and therefore the potential difference) and by reducing the internal short-circuit effect. The electrochemical generator is made safe even in the case of structural damage.

The absence of water makes it possible to avoid generating hydrogen, the main restriction to the use of aqueous extinguishing agents that may generate explosive atmospheres.

Advantageously, the pair of redox species is a metallic pair, preferably selected from Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules such as for example Cl₂/Cl⁻ or Cl⁻/Cl³⁻.

Advantageously, the ionic liquid solution comprises an additional ionic liquid.

Advantageously, the ionic liquid solution forms a deep eutectic solvent.

Advantageously, the electrochemical generator is immersed in the ionic liquid solution.

Advantageously, the discharge of the electrochemical generator is implemented at a temperature ranging from 0° C. to 100°, and preferably from 15° C. to 60° C.

Advantageously, the discharge of the electrochemical generator is implemented under air.

Advantageously, the method comprises, prior to the step of discharging the electrochemical generator, a dismantling step and/or a sorting step.

Advantageously, the method comprises, subsequently to the step of discharging the electrochemical generator, a storage step and/or a pyrometallurgical and/or hydrometallurgical step.

The neutralisation method according to the invention has numerous advantages: not implementing a wet grinding step, which avoids the problems related to the management of hydrogen, oxygen and heat, and therefore related to the management of explosive atmosphere (safety, treatment of effluents, additional financial cost), and which avoids using large volumes of water and treating aqueous effluent;

not using heat treatment, which avoids the problems related to the emission of gases (for example greenhouse gases or for any other gas that is harmful or dangerous for humans and the environment), in particular relating to any treatment thereof, and reduces the financial and energy costs of the method;

considerably reducing the constraints related to the use of water since ionic liquids are non-volatile, non-flammable and chemically stable at temperatures that may be above 200° C. (for example between 200° C. and 400° C.);

not requiring controlling the gaseous atmosphere when the batteries are opened, in particular by using inert gases, which simplifies the methods and makes it more economical;

being simple to implement.

Other features and advantages of the invention will emerge from the additional description that follows.

It goes without saying that this additional description is given merely by way of illustration of the object of the invention and must under no circumstances be interpreted as a limitation of this object.

### BRIEF DESCRIPTION OF THE DRAWINGS

The present invention will be understood better from a reading of the description of example embodiments given purely for indication and in no way limitatively, referring to the accompanying drawings, on which:

FIG. 1 schematically shows a view in cross section of a lithium-ion accumulator according to a particular embodiment of the invention,

FIG. 2 is an intensity-potential curve showing various redox potentials according to a particular embodiment of the invention,

The various parts shown in the figures are not necessarily shown to a uniform scale, to make the figures more legible.

The various possibilities (variants and embodiments) must be understood as not being exclusive of one another and may be combined with one another.

### DETAILED DESCRIPTION OF PARTICULAR EMBODIMENTS

Hereinafter, even if the description refers to a Li-ion accumulator, the invention can be transposed to any electrochemical generator, for example to a battery comprising a plurality of accumulators (also referred to as batteries of accumulators), connected in series or in parallel, according to the nominal operating voltage and/or the quantity of energy to be provided, or to an electrical cell.

These various electrochemical devices may be of the metal-ion type, for example lithium-ion or sodium-ion, or of the Li-metal type, etc.

It may also be a primary system such as Li/MnO₂, or a flow battery (“redox flow battery”).

An electrochemical generator having a potential greater than 1.5 V will advantageously be selected.

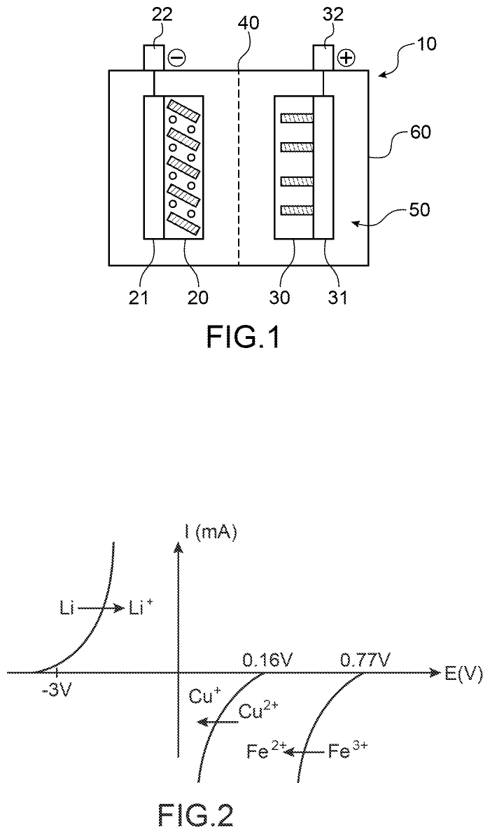

Reference is made first of all to FIG. 1, which shows a lithium-ion (or Li-ion) accumulator 10. A single electrochemical cell is shown but the generator may comprise a plurality of electrochemical cells, each cell comprising a first electrode 20, here the anode, and a second electrode 30, here the cathode, a separator 40 and an electrolyte 50. According to another embodiment, the first electrode 20 and the second electrode 30 could be reversed.

The anode (negative electrode) 20 is preferably based on carbon, for example graphite, which may be mixed with a binder of the PVDF type and deposited on a copper sheet. It may also be a mixed lithium oxide such as lithium titanate Li₄Ti₅O₁₂ (LTO) for a Li-ion accumulator, or a mixed sodium oxide such as sodium titanate for an Na-ion accumulator. It can also be a lithium alloy or a sodium alloy according to the technology selected.

The cathode (positive electrode) 30 is a lithium ion insertion material for a Li-ion accumulator. It may be a lamellar oxide of the LiMO₂ type, a phosphate LiMPO₄ with an olivine structure or a spinel compound LiMn₂O₄. M represents a transition metal. A positive electrode made from LiCoO₂, LiMnO₂, LiNiO₂, Li₃NiMnCoO₆ or LiFePO₄ will for example be selected.

The cathode (positive electrode) 30 is a sodium ion insertion material for an Na-ion accumulator. It may be a material of the sodiated oxide type comprising at least one metallic transition element, a material of the sodiated phosphate or sulfate type comprising at least one metallic transition element, a material of the sodiated fluoride type, or a material of the sulfide type comprising at least one metallic transition element.

The insertion material may be mixed with a binder of the polyvinylidene fluoride type and deposited on an aluminium sheet.

The electrolyte 50 includes lithium salts (LiPF₆, LiBF₄, LiClO₄ for example) or sodium salts (N₃Na for example), according to the accumulator technology chosen, solubilised in a mixture of non-aqueous solvents. The mixture of solvents is for example a binary or ternary mixture. The solvents are for example selected from solvents based on cyclic carbonates (ethylene carbonate, propylene carbonate, butylene carbonate), linear or branched (dimethyl carbonate, diethyl carbonate, ethyl methyl carbonate, dimethoxyethane) in diverse proportions.

Alternatively, it could be a case of a polymer electrolyte comprising a polymer matrix, made from organic and/or inorganic material, a liquid mixture comprising one or more metallic salts, and optionally a mechanical-reinforcement material. The polymer matrix may comprise one or more polymer materials, for example selected from a polyvinylidene fluoride (PVDF), a polyacrylonitrile (PAN), a polyvinylidene fluoride hexafluoropropylene (PVDF-HFP), or a poly(ionic liquid) of the poly(N-vinylimidazolium) bis(trifluoromethanesulfonylamide)), N, N-diethyl-N-(2-methoxyethyl)-N-methylammonium bis(trifluoromethylsulfonyl)imide (DEMM-TFSI) type.

The cell may be wound on itself about a winding axis or have a stacked architecture.

A casing 60, for example a polymer pouch, or a metal package, for example made from steel, provides the impermeability of the accumulator.

Each electrode 20, 30 is connected to a current collector 21, 31 passing through the casing 60 and forming, outside the casing 60, respectively the terminals 22, 32 (also referred to as output terminals or electrical terminals or poles). The function of the collectors 21, 31 is two-fold: providing the mechanical support for the active material and the electrical conduction as far as the terminals of the cell. The terminals (also referred to as electrical poles or terminals) form the output terminals and are intended to be connected to an “energy receiver”.

According to some configurations, one of the terminals 22, 32 (for example the one connected to the negative electrode) can be connected to the earth of the electrochemical generator. It is then said that the earth is the negative potential of the electrochemical generator and that the positive terminal is the positive potential of the electrochemical generator. The positive potential is therefore defined as the positive pole/terminal as well as all the metal parts connected by electrical continuity from this pole.

An intermediate electronic device may optionally be disposed between the terminal that is connected to earth and the latter.

The method for neutralising the electrochemical generator 10 comprises at least one step during which it is discharged in the presence of an ionic liquid solution 100 comprising an ionic liquid and a redox species able to react with the lithium so as to neutralise it, to make the electrochemical generator 10 safe.

Discharging means that the method makes it possible to significantly reduce the electrical charge of the electrochemical generator 10, by at least 50% and preferably by at least 80%, or even to completely discharge the electrochemical generator (100%). The discharge level depends on the initial state of charge.

This ionic liquid solution 100, also referred to as an ionic liquid solution, simultaneously prevents contact between the waste (cells or accumulators)/water/air and provides the discharge of the waste by means of the electrochemical redox species present in the ionic liquid. The whole is therefore made safe with respect to the fire triangle (oxidant, fuel, energy), avoiding/or minimising the presence of water giving rise to the formation of an explosive atmosphere (H₂, O₂ gas with heat).

The electrochemical generator 10 is preferably completely discharged. The free ions are immobilised in the cathode 30, where they form a thermodynamically stable metallic lithium oxide that does not react violently with water or air. This is done at low environmental and economic cost. In addition, the treatment is compatible with recycling the various components of the electrochemical generator 10 (in particular the electrolyte is not degraded). The discharge time will be estimated according to the nature of the cells and accumulators and the charge level.

The electrochemical generator 10 is at least partially covered with the ionic liquid solution 100. It is preferably completely immersed in the ionic liquid solution 100.

The ionic liquid solution 100 comprises at least one ionic liquid LI₁, referred to as a solvent ionic liquid, and a redox active species.

Ionic liquid means the association comprising at least one cation and one ion that generates a liquid with a melting point below or around 100° C. It is a case of molten salts.

Solvent ionic liquid means an ionic liquid that is stable on a thermal or electrochemical level minimising a degradation effect of the environment during the discharge phenomenon.

The ionic liquid solution 100 may also comprise an additional ionic liquid denoted LI₂ or a plurality (two, three, etc.) of additional ionic liquids, i.e. it comprises a mixture of a plurality of ionic liquids.

Additional ionic liquid means an ionic liquid that favours one or more properties with respect to the step of making safe and discharging. It may be a case, in particular, of one or more of the following properties: extinction, flame retarder, redox shuttle, salt stabiliser, viscosity, solubility, hydrophobicity, conductivity.

Advantageously, the ionic liquid, and optionally the additional ionic liquids, are liquid at ambient temperature (from 20 to 25° C.).

For the solvent ionic liquid and for the additional ionic liquid or liquids, the cation is preferably selected from the family: imidazolium, pyrrolidinium, ammonium, piperidinium and phosphonium.

A cation with a wide cationic window, sufficiently large to envisage a cathodic reaction avoiding or minimising the degradation of the ionic liquid, will advantageously be chosen.

Advantageously LI₁ and LI₂ will have the same cation to increase the solubility of LI₂ in LI₁. In the numerous possible systems, a non-toxic medium with low cost and low environmental impact (biodegradability) will be favoured.

Advantageously, anions making it possible to simultaneously obtain a wide electrochemical window, moderate viscosity, a low melting point (liquid at ambient temperature) and good solubility with the ionic liquid and the other species of the solution will be used, and this not leading to hydrolysis (degradation) of the ionic liquid.

The TFSI anion is an example that meets the criteria previously mentioned for numerous associations with, for example, for LI₁: [BMIM][TFSI], or the use of an ionic liquid of the [P66614][TFSI] type, the ionic liquid 1-ethyl-2,3-trimethyleneimidazolium bis(trifluoromethane sulfonyl)imide ([ETMIm][TFSI]), the ionic liquid N,N-diethyl-N-methyl-N-2-methoxyethyl ammonium bis(trifluoromethylsulfonyl)amide [DEME][TFSA], the ionic liquid N-methyl-N-butylpyrrolidinium bis(trifluoromethylsufonyl)imide ([PYR14][TFSI]), the ionic liquid N-methyl-N-propylpiperidinium bis(trifluoromethanesulfonyl) imide (PP13-TFSI).

The anion may also be of the bis(fluorosulfonyl)imide type (FSA or FSI), as the ionic liquid N-methyl-N-propylpyrrolidinium FSI (P13-FSI), N-methyl-N-propylpiperidinium FSI (PP13-FSI), 1-ethyl-3-methylimidazolium FSI (EMI-FSI), etc.

The anion of the solvent ionic liquid LI₁ and/or the ion of the additional ionic liquid LI₂ may advantageously be provided with a complexing anion for forming a complex with the electrochemical shuttle.

Other associations can be envisaged, with ionic liquids (I₁) the cation of which will be associated with an ion that will be either organic or inorganic, with preferentially a wide anodic window.

The ionic liquid solution advantageously forms a deep eutectic solvent (or DES). It is a case of a mixture liquid at ambient temperature obtained by forming a eutectic mixture of 2 salts, with the general formula:

[Cat]⁺.[X]⁻.z[Y]

with:
[Cat]⁺ is the cation of the solvent ionic liquid (for example ammonium),

[X]⁻ the halide anion (for example Cl⁻),

[Y] a Lewis or Brönsted acid, which can be complexed by the X⁻ anion of the solvent ionic liquid, and

z the number of molecules Y.

The eutectics can be divided into three categories depending on the nature of Y.

The first category corresponds to a type I eutectic:

Y=MClₓ with for example M=Fe, Zn, Sn, Fe, Al, Ga

The first category corresponds to a type II eutectic:

Y=MCIx.yH₂O with for example M=Cr, Co, Cu, Ni, Fe

The first category corresponds to a type III eutectic:

Y═RZ with for example Z═CONH₂, COOH, OH.

For example, the DES is choline chloride in association with an H bond donor with very low toxicity, such as glycerol or urea, which guarantees a non-toxic DES at very low cost.

According to another example embodiment, the choline chloride may be replaced by betaine. Even if these systems have a limited electrochemical stability window, they make it possible to guarantee the flooding and deactivation of an optionally open accumulator.

Advantageously, a compound “Y” that can fulfil the role of electrochemical shuttle that can be oxidised and/or reduced will be selected. For example, Y is a metal salt, able to be dissolved in the ionic liquid solution so as to form metallic ions. For example Y contains iron.

By way of illustration, it is possible to form a eutectic between an ionic liquid with a chloride ion and metallic salts FeCl₂ and FeCl₃ for various proportions and with various cations.

It is also possible to implement this type of reaction with type II eutectics that incorporate water molecules in the metallic salts when the proportion of water is small this will not cause any danger. Small typically means less than 10% by mass of the solution, for example 5 to 10% by mass of the solution.

It is also possible to use type III eutectics that associate the ionic liquid and hydrogen bond donor species (Y), with a mixture of the type [LI₁]/[Y] where LI₁ may be a quaternary ammonium and Y a complexing (hydrogen bond donor) molecule such as urea, ethylene glycol, thiourea, etc.

It is also possible to produce a mixture that will advantageously modify the properties of the solution for discharge of the medium. It is in particular possible to associate a solvent ionic liquid of the [BMIM][NTF₂] type that is very stable and liquid at ambient temperature, but which weakly solubilises the electrochemical shuttle (or redox mediator), such as an iron chloride.

For example, it is possible to associate an additional ionic liquid LI₂ of the [BMIM][CI] type that will favour the solubilisation of a metal salt in the form of a chloride by complexing with the LI₂ anion. This makes it possible to simultaneously have good transport properties and good solubility of the redox mediator and therefore favour the discharge phenomenon.

The solution comprises a redox species (also referred to as a redox mediator). This is an ion or a species in solution that can be oxidised on the negative electrode 20, or on the terminal 22 connected to the negative electrode 20.

The method proposed will make it possible to extract the lithium from the negative electrode in order to make the accumulator non-reactive in air.

The use of an electrochemical shuttle makes it possible to make the device operate in closed loop. It may be a case of an electrochemical pair or the association thereof. Preferably, it is a redox pair fulfilling the role of electrochemical shuttle (or of redox mediator) to reduce the degradation of the medium, by providing the redox reactions.

Redox pair means an oxidant and a reducer in solution capable of being respectively reduced and oxidised on the electrodes/terminals of the cells. The oxidant and the reducer may be introduced in equimolar or non-equimolar proportions.

The redox couple may be a metallic electrochemical pair or one of the associations thereof: Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

In the event of opening of the electrochemical generator, one of the redox species may come from the generator itself. It may in particular be cobalt, nickel and/or manganese.

The redox species and the redox pair may also be selected from organic molecules, and in particular from: 2,4,6-tri-t-butylphenoxyl, nitronyl nitroxide/2,2,6,6-tetramethyl-1-piperidinyloxy (TEMPO), tetracyanoethylene, tetramethylphenylenediamine, dihydrophenazine, aromatic molecules for example having a methoxy group, an N,N-dimethylamino group such as methoxybenzene anisole, dimethoxybenzene, or an N,N-dimethylaniline group such as N,N-dimethylaminobenzene. Mention can also be made of 10-methyl-phenothiazine (MPT), 2,5-di-tert-butyl-1,4-dimethoxybenzene (DDB) and 2-(pentafluorophenyl)-tetrafluoro-1,3,2-benzodioxaborole (PFPTFBDB).

It may also be a case of the metallocenes family (Fc/Fc+, Fe(bpy)₃(ClO₄)₂ and Fe(phen)₃(ClO₄)₂ and derivatives thereof) or the family of halogenated molecules (Cl₂/Cl⁻, Cl⁻/Cl³⁻ Br₂/Br⁻, I₂/I⁻, I⁻/I₃⁻).

A bromide or a chloride will in particular be selected. It is preferably a case of a chloride, which can easily complex the metals. For example, iron, complexed by the chloride anion, forms FeCl₄, which can reduce the reactivity of the negative electrode.

It may also be a case of tetramethylphenylenediamine.

It will also be possible to associate a plurality of redox pairs, wherein the metals of the metallic ions are identical or different.

For example Fe²⁺/Fe³⁺ and/or Cu⁺/Cu²⁺ will be selected. The latter are soluble in both the oxidation states thereof, they are not toxic, they do not degrade the ionic liquid and they have suitable redox potentials for extracting lithium (FIG. 2).

The solution may include an extinguishing agent and/or a flame retarder aimed at preventing thermal runaway, in particular in the case of opening of an accumulator. It may be an alkyl phosphate, optionally fluorinated (fluorinated alkyl phosphate), such as trimethyl phosphate, triethyl phosphatide, or tris(2,2,2-trifluoroethyl) phosphate. The concentration of active species may be from 80% by mass to 5%, preferably from 30% to 10% by mass.

Optionally, the ionic liquid solution may comprise a desiccating agent, and/or an agent favouring the transport of material, and/or a protective agent that is a stabiliser/reducer of corrosive and toxic species such as PF₅, HF, POF₃, etc.

The agent favouring the transport of material is for example a fraction of a co-solvent that can be added to reduce viscosity.

It may be a case of a small proportion of water, such as 5% water.

Preferably, an organic solvent will be selected to act effectively without giving rise to risks with respect to discharge and/or flammability. It may be de vinylene carbonate (VC), gamma-butyrolactone (γ-BL), propylene carbonate (PC), poly(ethylene glycol), or dimethyl ether. The concentration of agent favouring the transport of material advantageously ranges from 1% to 40% and more advantageously from 10% to 40% by mass.

The protective agent able to reduce and/or stabilise corrosive and/or toxic elements is for example a compound of the butylamine type, a carbodiimide (of the type N,N-dicyclohexylcarbodiimide), (N,N-diethylamino)trimethylsilane, le tris(2,2,2-trifluoroethyl) phosphite (TTFP), a compound based on amine such as 1-methyl-2-pyrrolidinone, a fluorinated carbamate or hexamethylphosphoramide. This may also be a compound of the cyclophosphazene family such as hexamethoxycyclotriphosphazene.

Advantageously, the ionic liquid solution comprises less than 10% by mass water, preferentially less than 5% by mass.

Even more preferentially, the ionic liquid solution contains no water.

The method can be implemented at temperatures ranging from 0° C. to 100° C., preferably from 20° C. to 60° C. and even more preferentially it is implemented at ambient temperature (20-25° C.).

The method can be implemented under air, or under inert atmosphere, for example argon, carbon dioxide, nitrogen or one of the mixtures thereof.

In the case where the electrochemical generator is immersed in the ionic solution, the solution can be stirred to improve the addition of reagent. For example, it may be stirring between 50 and 2000 rpm, and preferably between 200 and 800 rpm.

The neutralisation step may last from 1 h to 150 h, for example from 10 h to 100 h and preferably from 72 h to 96 h.

The neutralisation method makes it possible to make the electrochemical generator safe with a view to recycling thereof (by pyrometallurgical or hydrometallurgical method or a combination thereof) or the storage thereof. For example, it may be a case of temporary storage while awaiting transferring it, for example in a recycling factory for reprocessing these various components.

By way of illustration, a recycling method may comprise the following steps: sorting, dismantling, neutralisation, recycling by conventional methods (pyrometallurgical, hydrometallurgical, etc.).

Opening the electrochemical generator 10 for accessing the reprocessable fractions thereof can be done in complete safety.

### ILLUSTRATIVE AND NON-LIMITATIVE EXAMPLES OF AN EMBODIMENT

### Example 1: Discharge in a BMIM-Cl/FeCl₃.6H₂O/FeCl₂.4H₂O Medium

The ionic liquid solution is a mixture comprising the ionic liquid BMIMCl and the salts thereof FeCl₃.6H₂O and FeCl₂.4H₂O. These three components are in equimolar quantities of the three chemical products.

After the solution is dried, a cell of the Li-ion 18650 type is put in contact with 50 ml of the ionic liquid solution at ambient temperature under stirring of rpm. After 96 hours, the cell is extracted from the bath and the voltage of the cell is zero, indicating discharge of the system.

### Example 2: Discharge in 1M BMIM NTf₂ BMIM-Cl/0.5M FeCl₃.6H₂O and 0.5M FeCl₂.4H₂O Medium

The ionic liquid solution is a mixture comprising the following components: BMIM NTf₂ and BMIMCl (1M), FeCl₃.6H₂O et FeCl₂.4H₂O (0.5M).

After the solution is dried, a cell of the Li-ion 18650 type is put in contact with 50 ml of the ionic liquid solution at ambient temperature under stirring of 800 rpm. After 96 hours, the cell is extracted from the bath and the voltage of the cell is zero, indicating discharge of the system.

What is claimed is:

1.-10. (canceled)

11. A method for neutralising an electrochemical generator comprising a negative electrode containing lithium or sodium and a positive electrode, the method comprising a discharge step during which the electrochemical generator is put in contact with an ionic liquid solution comprising a solvent ionic liquid and a so-called oxidising redox species able to be reduced on the negative electrode so as to discharge the electrochemical generator.

12. The method according to claim 1, wherein the ionic liquid solution comprises a second so-called reducing redox species able to be oxidised on the positive electrode, the so-called oxidising redox species and the so-called reducing redox species forming a redox species pair.

13. The method according to claim 12, wherein the redox species pair is a metal pair, a pair of organic molecules, a pair of metallocenes, or a pair of halogenated molecules.

14. The method according to claim 13, wherein the redox species pair is a metal pair selected from the group consisting of Mn²⁺/Mn³⁺, CO²⁺/Co³⁺ Cr²⁺/Cr³⁺, Cr³⁺/Cr⁶⁺, V²⁺/N³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

15. The method according to claim 13, wherein the redox species pair is a pair of metallocenes being Fc/Fc⁺.

16. The method according to claim 13, wherein the redox species pair is a pair of halogenated molecules selected from the group consisting of Cl₂/Cl⁻ or Cl⁻/Cl³⁻.

17. The method according to claim 11, wherein the ionic liquid solution comprises an additional ionic liquid.

18. The method according to claim 11, wherein the ionic liquid solution forms a deep eutectic solvent.

19. The method according to claim 11, wherein the electrochemical generator is immersed in the ionic liquid solution.

20. The method according to claim 11, wherein the electrochemical generator is discharged at a temperature ranging from 0° C. to 100°.

21. The method according to claim 11, wherein the electrochemical generator is discharged at a temperature ranging from 15° C. to 60° C.

22. The method according to claim 11, wherein the electrochemical generator is discharged under air.

23. The method according to claim 11, wherein it comprises, prior to the step of discharging the electrochemical generator, a dismantling step or a sorting step.

24. The method according to claim 11, wherein it comprises, subsequent to the step of discharging the electrochemical generator, a storage step, a pyrometallurgical or a hydrometallurgical step.
